(19) United States
(12) Patent Application Publication
(10) Pub. No.: US 2015/0194114 A1
(43) Pub. Date: Jul. 9, 2015

(54) SEMICONDUCTOR DEVICE AND METHOD FOR CONTROLLING THE SAME

(71) Applicant: SAMSUNG ELECTRONICS CO., LTD., Suwon-Si (KR)

(72) Inventor: BO-YOUNG KIM, Hwaseong-Si (KR)

(21) Appl. No.: 14/525,337

(22) Filed: Oct. 28, 2014

(30) Foreign Application Priority Data
Jan. 8, 2014 (KR) 10-2014-0002433

(51) Int. Cl. G09G 3/36

(52) U.S. Cl. CPC G09G 3/3674; G09G 2310/061; G09G 2300/0814; G09G 2330/023; G09G 2370/08

(57) ABSTRACT

A pulse counting unit outputs a pulse count signal obtained by counting pulses of a first pulse signal received from a display module, and resets the pulse count signal when a value of the pulse count signal reaches an upper limit value. A mask pulse signal generation unit generates a mask pulse signal having a pulse corresponding to a reset period of the pulse count signal. A logical operation unit performs an AND operation on the first pulse signal and the mask pulse signal. A pulse signal generation unit uses a signal output by the logical operation unit to generate a second pulse signal having substantially the same pulse width as that of the first pulse signal. The pulse rate of the second pulse signal is substantially the same as a frame rate of multimedia data to be reproduced in the display module.

### CROSS-REFERENCE TO RELATED APPLICATIONS

This application claims priority under 35 U.S.C. §119 to Korean Patent Application No. 10-2014-0002433 filed on Jan. 8, 2014, the disclosure of which is incorporated by reference herein in its entirety.

### TECHNICAL FIELD

Exemplary embodiments of the present inventive concept relate to a semiconductor device and a method for controlling the same.

### DISCUSSION OF THE RELATED ART

As the resolution of display devices increases, the size of multimedia data (e.g., image data) to be displayed on display devices is also increasing. As a result, input/output overhead for processing the data is increasing, and power consumption due to input/output operations is also increasing. The increase in power consumption, particularly in mobile devices, affects the performance of the devices.

### SUMMARY

Exemplary embodiments of the present inventive concept provide a semiconductor device that content-adaptively operates a clock signal of a display controller based on attributes of content to be reproduced in a display device.

Exemplary embodiments of the present inventive concept further provide a method for controlling a semiconductor device that content-adaptively operates a clock signal of a display controller based on attributes of content to be reproduced in a display device.

According to an exemplary embodiment of the present inventive concept, a semiconductor device includes a pulse counting unit configured to output a pulse count signal obtained by counting pulses of a first pulse signal received from a display module, and reset the pulse count signal when a value of the pulse count signal reaches a preset upper limit value. The semiconductor device further includes a mask pulse signal generation unit configured to generate a mask pulse signal having a pulse corresponding to a reset period of the pulse count signal. The semiconductor device further includes a logical operation unit configured to perform an AND operation on the first pulse signal and the mask pulse signal. The semiconductor device further includes a pulse signal generation unit configured to generate a second pulse signal using a signal output by the logical operation unit. The second pulse signal has substantially the same pulse width as that of the first pulse signal, and a pulse rate of the second pulse signal is substantially the same as a frame rate of multimedia data to be reproduced in the display module.

According to an exemplary embodiment of the present inventive concept, a semiconductor device includes a pulse signal control unit configured to reduce a pulse rate of a first pulse signal received from a display module, and generate a second pulse signal based on the first pulse signal. The semiconductor device further includes a processing unit configured to calculate a ratio of the pulse rate of the first pulse signal to a frame rate of multimedia data stored in a memory, and control an operation of the pulse signal control unit. The semiconductor device further includes a display controller configured to transmit the multimedia data to the display module based on a pulse rate of the second pulse signal. The pulse rate of the second pulse signal is substantially the same as the frame rate of the multimedia data.

According to an exemplary embodiment of the present inventive concept, a method of controlling a semiconductor device includes counting pulses of a first pulse signal received from a display module, generating a pulse count signal based on the counted pulses of the first pulse signal, resetting the pulse count signal when a value of the pulse count signal reaches a preset upper limit value, generating a mask pulse signal having a pulse corresponding to a reset period of the pulse count signal, performing an AND operation on the first pulse signal and the mask pulse signal, and generating a second pulse signal having substantially the same pulse width as a pulse width of the first pulse signal. A pulse rate of the second pulse signal is substantially the same as a frame rate of multimedia data to be reproduced in the display module.

### BRIEF DESCRIPTION OF THE DRAWINGS

The above and other features of the present inventive concept will become more apparent by describing in detail exemplary embodiments thereof with reference to the accompanying drawings, in which:

FIGS. 1 and 2 are schematic diagrams illustrating a semiconductor device according to an exemplary embodiment of the present inventive concept.

FIG. 3 is a schematic diagram illustrating a semiconductor device according to an exemplary embodiment of the present inventive concept.

FIG. 4 is a conceptual diagram illustrating that a clock signal of a display controller is content-adaptively converted according to an exemplary embodiment of the present inventive concept.

FIG. 5 is a diagram illustrating the semiconductor device according to an exemplary embodiment of the present inventive concept converting a first pulse signal to a second pulse signal.

FIG. 6 is a diagram illustrating the semiconductor device according to an exemplary embodiment of the present inventive concept converting a first pulse signal to a second pulse signal.

FIG. 7 is a schematic diagram illustrating a semiconductor device according to an exemplary embodiment of the present inventive concept.

FIG. 8 is a schematic diagram illustrating a semiconductor device according to an exemplary embodiment of the present inventive concept.

FIG. 9 is a flowchart illustrating a method for controlling a semiconductor device according to an exemplary embodiment of the present inventive concept.

FIG. 10 is a diagram illustrating a semiconductor device according to an exemplary embodiment of the present inventive step converting a first pulse signal to a second pulse signal.

FIG. 11 is a flowchart illustrating a method for controlling a semiconductor device according to an exemplary embodiment of the present inventive concept.

FIG. 12 is a schematic block diagram illustrating an exemplary electronic system including semiconductor devices according to exemplary embodiments of the present inventive concept.

FIG. 13 is a schematic block diagram illustrating an exemplary electronic system including semiconductor devices according to exemplary embodiments of the present inventive concept.

### DETAILED DESCRIPTION OF THE EXEMPLARY EMBODIMENTS

Exemplary embodiments of the present inventive concept will be described more fully hereinafter with reference to the accompanying drawings. Like reference numerals may refer to like elements throughout the accompanying drawings.

It will be understood that when an element or layer is referred to as being “on”, “connected to” or “coupled to” another element or layer, it can be directly on, connected or coupled to the other element or layer or intervening elements or layers may be present.

It will be understood that, although the terms first, second, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

Herein, when two or more elements (e.g., pulse widths, pulse rates, frame rates, etc.) are described as being substantially the same as each other, it is to be understood that the elements are identical to each other, indistinguishable from each other, or distinguishable from each other but functionally the same as each other as would be understood by a person having ordinary skill in the art.

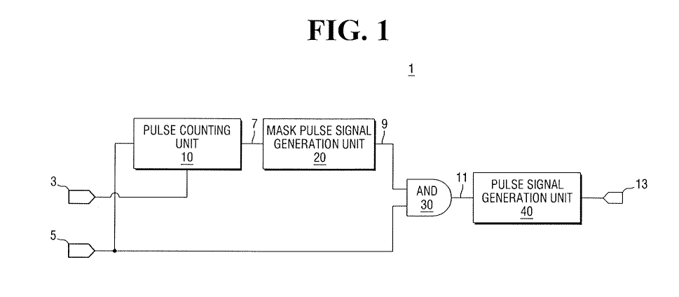

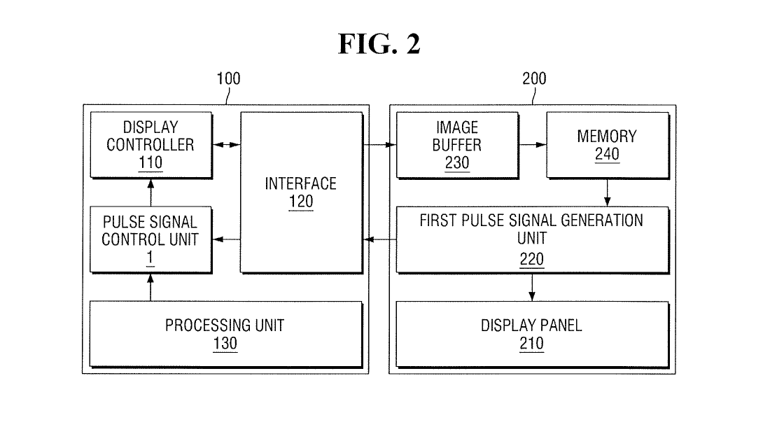

FIGS. 1 and 2 are schematic diagrams illustrating a semiconductor device according to an exemplary embodiment of the present inventive step.

Referring to FIG. 1, the semiconductor device according to an exemplary embodiment includes a pulse signal control unit 1 including a pulse counting unit 10, a mask pulse signal generation unit 20, a logical operation unit 30 (e.g., an AND gate), and a pulse signal generation unit 40.

The pulse signal control unit 1 may convert a first pulse signal 5 to a second pulse signal 13. For example, the pulse signal control unit 1 may generate the second pulse signal 13 by reducing a pulse rate of the first pulse signal 5. The first pulse signal 5 may include, for example, a plurality of pulses having a constant cycle.

Referring to FIG. 2, the first pulse signal 5 may be generated by a display module 200, which includes, for example, a first pulse signal generation unit 220. The first pulse signal generation unit 220 may be connected to a computing system 100 including the pulse signal control unit 1, and the first pulse signal 5 may be transmitted to the computing system 100 via the first pulse signal generation unit 220. In exemplary embodiments, the display module 200 may include, for example, a liquid crystal display (LCD) module, and the first pulse signal 5 may include, for example, a tearing effect (TE) signal received from the LCD module.

The TE signal may be, for example, a pulse signal generated by the display module 200 and provided to the computing system 100 for the purpose of preventing image tearing from occurring at the display module 200. Referring to FIG. 1, the second pulse signal 13 may be, for example, a pulse signal having a pulse rate that is about equal to or less than that of the first pulse signal 5, and may be used as a clock signal or a trigger signal of a display controller 110 of the computing system 100 for controlling the display module 200.

Referring to FIG. 1, the pulse counting unit 10 outputs a pulse count signal 7, which may be obtained by sequentially counting pulses of the first pulse signal 5(e.g., values of the pulse count signal 7 may be count values obtained by sequentially counting the pulses of the first pulse signal 5). For example, a count value may be ‘3’ when 3 pulses are counted. The pulse counting unit 10 may reset the pulse count signal 7 when the value of the pulse count signal 7 reaches a preset upper limit value 3. For example, the pulse counting unit 10 counts the pulses of the first pulse signal 5 and resets the count value to, for example, ‘0’ when the count value reaches the upper limit value 3. That is, the pulse counting unit 10 counts the pulses of the first pulse signal 5 and resets the count value upon determining that the count value has reached the upper limit value 3. Once reset, pulses may again be counted. In exemplary embodiments, the upper limit value 3 may be computed by the computing system 100 or may be provided from a source external to the computing system 100. As shown in FIG. 1, the upper limit value 3 may be input to the pulse counting unit 10.

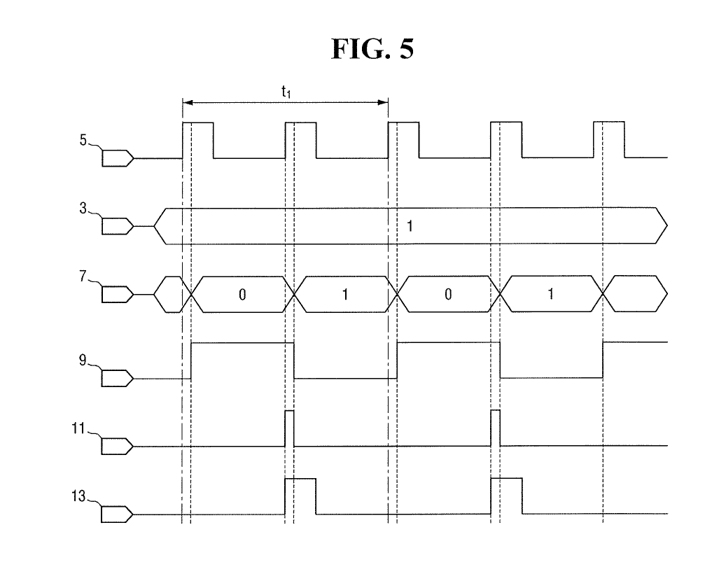

The mask pulse signal generation unit 20 receives the pulse count signal 7 output from the pulse counting unit 10, and generates a mask pulse signal 9 having pulses corresponding to a period reset by the pulse count signal 7. For example, in an exemplary scenario, when the count values output from the pulse count signal 7 are ‘0’, ‘1’, ‘2’, ‘0’, ‘1’, and ‘2’, the mask pulse signal 9 may have pulses only in a period in which a count value of the pulse count signal 7 is ‘0’. That is, the mask pulse signal 9 is provided for eliminating some of a plurality of pulses included in a particular period on the first pulse signal 5. For example, in an exemplary scenario, when the count values of the pulse count signal 7 are ‘0’, ‘1’, ‘2’, ‘0’, ‘1’, and ‘2’, selecting only the period in which a count value of the pulse count signal 7 is ‘0’ corresponds to selecting only the first one from among 3 consecutive pulses of the first pulse signal 5. This is described in further detail with reference to FIG. 5.

The logical operation unit 30 may be, for example, an AND gate. The logical operation unit 30 may perform an AND operation on the first pulse signal 5, which may be input (e.g., directly input) to the logical operation unit 30, and the mask pulse signal 9 output from the mask pulse signal generation unit 20. Since the signal 11 output from the logical operation unit 30 may have irregular pulse widths and may not be suitable to be used as a clock signal or a trigger signal, the pulse signal generation unit 40 may correct the signal when necessary and generate the second pulse signal 13 having substantially the same pulse width as that of the first pulse signal 5. As described above, the generated second pulse signal 13 may be used as the clock signal or the trigger signal of the display controller 110 for controlling the display module 200. The pulse rate of the second pulse signal 13 may be substantially the same as a frame rate of multimedia data (e.g., image data) to be reproduced in the display module 200.

Referring to FIG. 2, the computing system 100 including the pulse signal control unit 1 is connected to the display module 200.

In an exemplary embodiment, the computing system 100 includes the pulse signal control unit 1, the display controller 110, an interface 120, and a processing unit 130. As described above, the pulse signal control unit 1 may reduce a pulse rate of the first pulse signal 5 received from the display module 200 and generate the second pulse signal 13. The processing unit 130 may compute a ratio of the pulse rate of the first pulse signal 5 to the frame rate of the multimedia data to be reproduced in the display module 200, and may control the operation of the pulse signal control unit 1. The display controller 110 may transmit the multimedia data to the display module 200 through the interface 120 at the pulse rate of the second pulse signal 13. That is, the display controller 110 may transmit the multimedia data to the display module 200 through the interface 120 based on (e.g., in coordination with) the pulse rate of the second pulse signal 13. As described above, the pulse rate of the second pulse signal 13 may be substantially the same as the frame rate of the multimedia data to be reproduced in the display module 200. In exemplary embodiments, the display controller 110 and the display module 200 may interface with each other using, for example, a display serial interface (DSI) based on a mobile industry processor interface (MIPI).

In an exemplary embodiment, the display module 200 includes a display panel 210, the first pulse signal generation unit 220, an image buffer 230, and a memory 240. The display panel 210 visually displays the multimedia data and may include, for example, an LCD panel. The first pulse signal generation unit 220 may generate the first pulse signal 5 depending on hardware characteristics of the display module 200. For example, the first pulse signal 5 may be a TE signal for preventing image tearing. The multimedia data provided by the computing system 100 is displayed on the display panel 210 using the image buffer 230 and the memory 240.

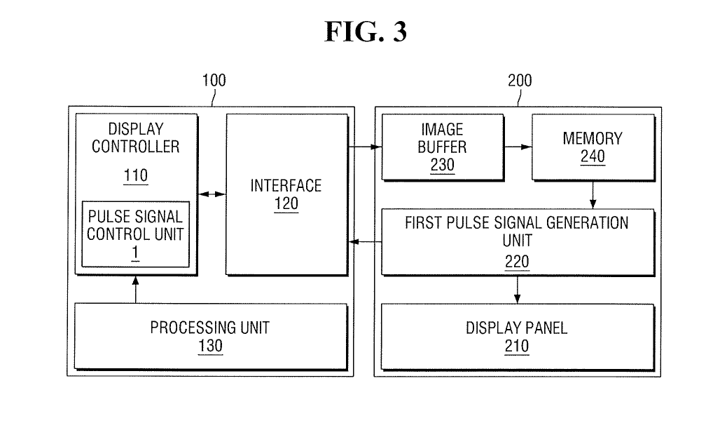

FIG. 3 is a schematic diagram illustrating a semiconductor device according to an exemplary embodiment of the present inventive concept.

Referring to FIG. 3, the semiconductor device according to an exemplary embodiment of the present inventive concept includes a pulse signal control unit 1 including a pulse counting unit 10, a mask pulse signal generation unit 20, a logical operation unit 30 (e.g., an AND gate), and a pulse signal generation unit 40 (see FIG. 1). However, in comparison to the semiconductor device shown in FIG. 2, the pulse signal control unit 1 is implemented as a component of the display controller 110. That is, in comparison to the semiconductor device shown in FIG. 2, in which a second pulse signal 13 that is used as a clock signal or a trigger signal for driving the display controller 110 is provided from the pulse signal control unit 1 that is disposed external to the display controller 110, the display controller 110 in FIG. 3 receives (e.g., directly receives) the first pulse signal 5 from the display module 200 (e.g., from the first pulse signal generation unit 220), and then converts the first pulse signal 5 to the second pulse signal 13 within the display controller 110.

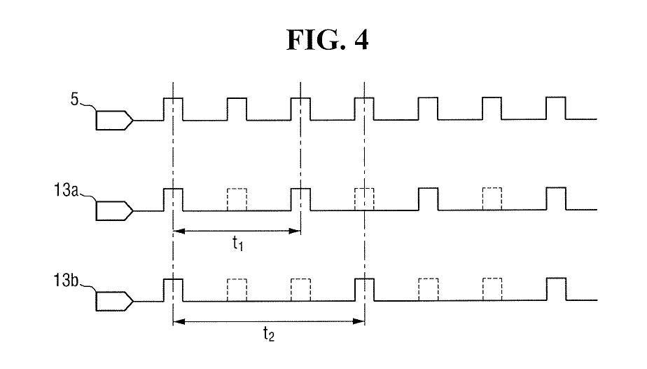

FIG. 4 is a conceptual diagram illustrating that a clock signal of a display controller is content-adaptively converted according to an exemplary embodiment of the present inventive concept.

Referring to FIG. 4, it is assumed that the first pulse signal 5 is a pulse signal having a pulse rate of, for example,60 Hz. In this case, in order to reproduce multimedia data in the display module 200, in a comparative example, the display controller 110 may provide image data to the display module 200 at a rate of 60 Hz according to the first pulse signal 5 provided by the display module 200 (e.g., the TE signal provided by the LCD module). In this case, however, even when it is not necessary to renew the multimedia data at the rate of 60 Hz (e.g., even when the frame rate of the multimedia data does not reach 60 Hz), since the display controller 110 collectively provides image data to the display module 200 at the rate of 60 Hz, unnecessarily excessive overhead in inputting/outputting data may be generated, thereby resulting in unnecessary power consumption. To avoid excessive overhead and reduce power consumption, semiconductor devices according to exemplary embodiments of the present inventive concept content-adaptively operate the clock signal of the display controller 110 (e.g., the first pulse signal 5), thereby reducing data input/output processing amounts.

The second pulse signal 13 may include second pulse signals 13a and 13b. According to exemplary embodiments, the pulse rate of the second pulse signals 13a and 13b may be reduced to become substantially the same as the frame rate of the multimedia data to be reproduced in the display module 200. For example, when multimedia data having a pulse rate of 30 Hz is reproduced, the pulse rate of the second pulse signal 13a may be adjusted to become 30 Hz, and when multimedia data having a pulse rate of 20 Hz is reproduced, the pulse rate of the second pulse signal 13b may be adjusted to become 20 Hz. Accordingly, a pulse interval t1 of the second pulse signal 13a may become about twice the size of a pulse interval of the first pulse signal 5, and a pulse interval t2 of the second pulse signal 13b may become about three times the size of a pulse interval of the first pulse signal 5. Adjustment of the pulse rate may be performed, for example, by skipping some pulses of the first pulse signal 5 transmitted through the pulse signal control unit 1 of the semiconductor devices according to exemplary embodiments of the present inventive concept.

FIG. 5 is a diagram illustrating the semiconductor device according to an exemplary embodiment of the present inventive step converting a first pulse signal to a second pulse signal.

Referring to FIG. 5, the first pulse signal 5 is a signal having two pulses for a period of t1 . As described above, the pulse counting unit 10 sequentially counts the pulses of the first pulse signal 5, resets accumulated count values when the count value reaches the upper limit value 3 , and sequentially counts the pulses of the first pulse signal 5. Assuming that, in an example, the upper limit value 'input to the pulse counting unit 10 is ‘1’ and the pulse counting unit 10 counts pulses starting at ‘0’, as shown in FIG. 5, the pulse count signal 7 will repeatedly have count values of ‘0’ and ‘1’. In exemplary embodiments, the upper limit value 3 may be computed based on a ratio of the pulse rate of the first pulse signal 5 to the frame rate of the multimedia data to be reproduced in the display module 200. In exemplary embodiments, the pulse counting unit 10 may count pulses at rising edges of the pulses of the first pulse signal 5. However, exemplary embodiments of the present inventive concept are not limited thereto. For example, in exemplary embodiments, the pulse counting unit 10 may count pulses at falling edges of the pulses of the first pulse signal 5.

Next, in order to skip the pulse corresponding to ‘1’ of the two pulses for the time period t1 of the first pulse signal 5, a mask pulse signal 9 may be generated by the mask pulse signal generation unit 20. As described above, and as shown in FIG. 5, the mask pulse signal 9 may have pulses only in periods in which count values of the pulse count signal 7 are ‘0’, resulting in only the first pulse of two consecutive pulses for the time period t1 of the first pulse signal 5 being selected. Thus, according to exemplary embodiments of the present inventive concept, the pulse rate of the first pulse signal 5 may be reduced to half (½) of its original value.

Thereafter, in order to generate the second pulse signal 13 to be used as, for example, a clock signal or trigger signal in the display controller 110, an AND operation may be performed on the mask pulse signal 9 and the first pulse signal 5, and pulse widths of the resulting signal 11 may be corrected using the pulse signal generation unit 40, thereby generating the second pulse signal 13 having a lower pulse rate than the first pulse signal 5 and having substantially the same pulse width as the first pulse signal 5. As shown in FIG. 5, for the time period t1, the number of pulses of the first pulse signal 5 is 2, and the number of pulses of the second pulse signal 13 is 1. In addition, assuming that the first pulse signal 5 has a pulse rate of, for example, 60 Hz, the converted second pulse signal 13 will have a pulse rate of 30 Hz.

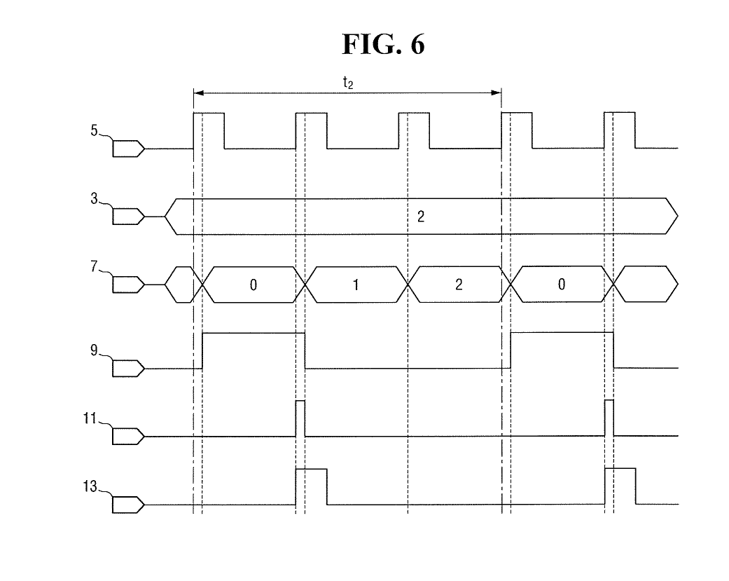

FIG. 6 is a diagram illustrating the semiconductor device according to an exemplary embodiment of the present inventive concept converting a first pulse signal to a second pulse signal.

Referring to FIG. 6, the first pulse signal 5 is a signal having three pulses for a period of t2. Assuming that, in an example, the upper limit value 3 input to the pulse counting unit 10 is ‘2’ and the pulse counting unit 10 counts pulses starting at ‘0’, as shown in FIG. 6, the pulse count signal 7 will repeatedly have count values of ‘0’, ‘1’, and ‘2’.

Next, in order to skip the pulses corresponding to ‘1’ and ‘2’ of the three pulses for the time period t2 of the first pulse signal 5, a mask pulse signal 9 may be generated by the mask pulse signal generation unit 20. As described above, and as shown in FIG. 6, the mask pulse signal 9 may have pulses only in periods in which count values of the pulse count signal 7 are ‘0’, resulting in only the first pulse from among three consecutive pulses for the time period t2 of the first pulse signal 5 being selected. Thus, according to exemplary embodiments of the present inventive concept, the pulse rate of the first pulse signal 5 may be reduced to one third (⅓) of its original value.

Thereafter, in order to generate the second pulse signal 13 to be used as, for example, a clock signal or trigger signal in the display controller 110, an AND operation may be performed on the mask pulse signal 9 and the first pulse signal 5, and pulse widths of the resulting signal 11 may be corrected using the pulse signal generation unit 40, thereby generating the second pulse signal 13 having a lower pulse rate than the first pulse signal 5 and having substantially the same pulse width as the first pulse signal 5. As shown in FIG. 6, for the time period t2 , the number of pulses of the first pulse signal 5 is 3, and the number of pulses of the second pulse signal 13 is 1. In addition, assuming that the first pulse signal 5 has a pulse rate of, for example, 60 Hz, the converted second pulse signal 13 will have a pulse rate of 20 Hz.

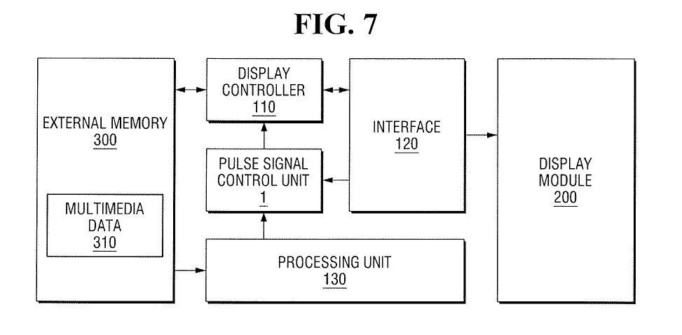

FIG. 7 is a schematic diagram illustrating a semiconductor device according to an exemplary embodiment of the present inventive concept.

Referring to FIG. 7, the semiconductor device according to an exemplary embodiment may access a memory (e.g., an external memory 300) at the pulse rate of the second pulse signal 13. That is, the time at which the semiconductor device accesses the external memory 300 may be based on (e.g., in coordination with) the pulse rate of the second pulse signal 13. For example, the first pulse signal 5 received from the display module 200 is converted to the second pulse signal 13 by the pulse signal control unit 1 and is then provided to the display controller 110. The display controller 110 may read an image frame of multimedia data 310 stored in the external memory 300 at the pulse rate of the second pulse signal 13, and then transmit the read image frame to the display module 200. That is, the display controller 110 may read an image frame of the multimedia data 310 stored in the external memory 300 based on (e.g., in coordination with) the pulse rate of the second pulse signal 13, and then transmit the read image frame to the display module 200. In a comparative example, even when it is not necessary to renew the multimedia data 310 at 60 Hz (e.g., even when the frame rate of the multimedia data does not reach 60 Hz), since the display controller 110 collectively reads the image data from an external memory at the rate of 60 Hz, unnecessarily excessive overhead in inputting/outputting data may be generated, thereby resulting in unnecessary power consumption. To avoid this, semiconductor devices according to exemplary embodiments of the present inventive concept content-adaptively operate the clock signal of the display controller 110 (e.g., the first pulse signal 5), thereby reducing the number of times the display controller 110 accesses the external memory 300, and reducing data input/output processing amounts.

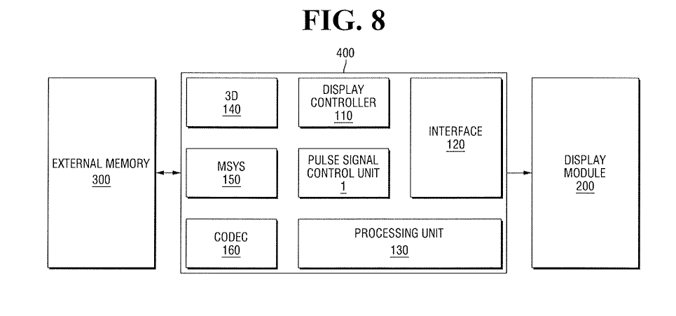

FIG. 8 is a schematic diagram illustrating a semiconductor device according to an exemplary embodiment of the present inventive concept.

Referring to FIG. 8, the semiconductor device according to an exemplary embodiment of the present inventive concept may be implemented as a system-on-chip

(SoC). For example, the pulse signal control unit 1, the display controller 110, and the processing unit 130 may be connected to each other through an internal bus incorporated into the SoC (e.g., a bus complying with the AMBA advanced eXtensible interface (AXI) protocol). In exemplary embodiments, the SoC may be implemented as an application processor (AP) mounted on a mobile terminal. In exemplary embodiments, the SoC may further include the interface 120, a 3D unit 140, an MSYS unit 150, and a CODEC unit 160, and may be connected to the display module 200 and the external memory 300.

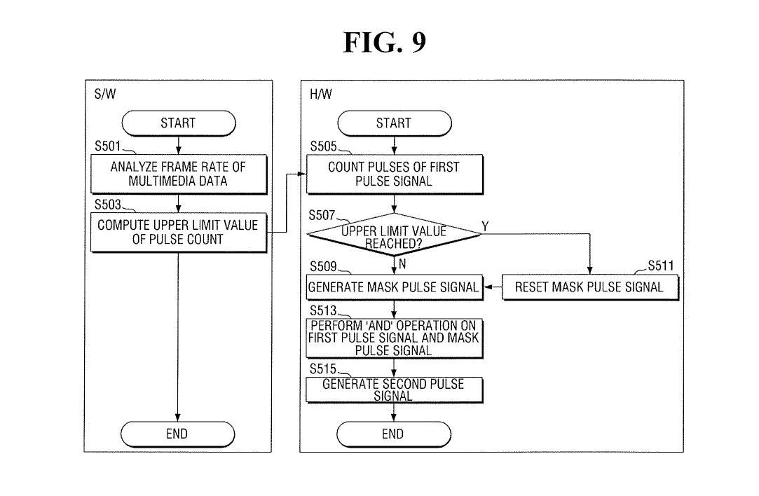

FIG. 9 is a flowchart illustrating a method for controlling a semiconductor device according to an exemplary embodiment of the present inventive concept.

Referring to FIG. 9, the method for controlling the semiconductor device according to an exemplary embodiment of the present inventive concept may be performed using software and hardware implementations.

Referring to the software implementation, the processing unit 130 of the computing system 100 analyzes a frame rate of the multimedia data 310 to be reproduced in the display module 200 at S501. In exemplary embodiments, multimedia data 310 may be stored in, for example, the external memory 300 connected to the computing system 100, a hard disk drive (HDD), or a solid state drive (SSD). The processing unit 130 computes the upper limit value 3 of pulse counts based on the frame rate of the multimedia data 310 to be reproduced in the display module 200 and the pulse rate of the first pulse signal 5 generated by the display module 200 at S503. The computed upper limit value 3 and the first pulse signal 5 may be input (e.g., directly input) to the pulse counting unit 10 of the pulse signal control unit 1.

Referring to the hardware implementation, the pulse counting unit 10 outputs the pulse count signal 7 obtained by counting pulses of the first pulse signal 5 at S505, and determines whether a value of the pulse count signal 7 has reached the preset upper limit value 3 at S507. If the value of the pulse count signal 7 has not reached the preset upper limit value 3, the mask pulse signal 9 having pulses corresponding to a reset period of the pulse count signal 7 is generated at S509. If the value of the pulse count signal 7 has reached the preset upper limit value 3, the pulse count signal 7 is reset at S511. Next, an AND operation is performed on the first pulse signal 5 and the mask pulse signal 9 at S513. Then, the resulting signal 11 is corrected to generate the second pulse signal 13 having substantially the same pulse width as that of the first pulse signal 5 (e.g., the second pulse signal 13 is generated using the resulting signal 11 output by the logical operation unit 30). As described above, according to exemplary embodiments, content-adaptively converting the first pulse signal 5 to the second pulse signal 13 based on the multimedia data 310 may be processed via hardware, thereby relieving a work load of the processing unit 130 of the computing system 100.

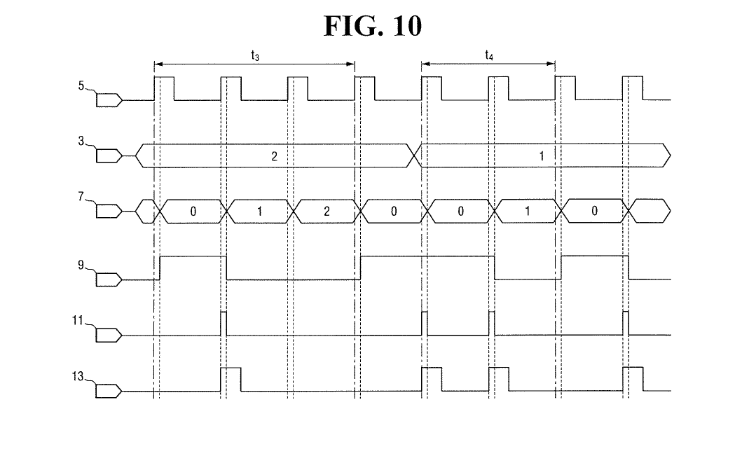

FIG. 10 is a diagram illustrating a semiconductor device according to an exemplary embodiment of the present inventive concept converting a first pulse signal to a second pulse signal.

Referring to FIG. 10, when the frame rate of the multimedia data 310 to be reproduced in the display module 200 is changed, the second pulse signal 13 conforming to the frame rate of the multimedia data 310 is generated by recomputing the upper limit value 3 . For example, assuming that, in an example, the upper limit value 3 input to the pulse counting unit 10 according to the frame rate of the multimedia data 310 is ‘2’ and the pulse counting unit 10 counts pulses starting at ‘0’, as shown in FIG. 10, the pulse count signal 7 will repeatedly have count values of ‘0’, ‘1’, and ‘2’. Next, in order to skip the pulses corresponding to ‘1’ and ‘2’ of the three pulses for the time period t3 of the first pulse signal 5, a mask pulse signal 9 may be generated by the mask pulse signal generation unit 20. Thus, according to exemplary embodiments of the present inventive concept, the pulse rate of the first pulse signal 5 may be reduced to one third (⅓) of its original value.

Thereafter, if the frame rate of the multimedia data 310 is changed, the processing unit 130 may recompute the upper limit value 3 based on the changed frame rate. For example, assuming that the upper limit value 3 input to the pulse counting unit 10 according to the changed frame rate of the multimedia data 310 is and the pulse counting unit 10 counts pulses starting at ‘0’, as shown in FIG. 10, the pulse count signal 7 will repeatedly have count values of ‘0’ and ‘1’. Next, in order to skip the pulses corresponding to ‘1’ of two pulses for a time period t4 of the first pulse signal 5, a mask pulse signal 9 may be generated by the mask pulse signal generation unit 20. Thus, according to exemplary embodiments of the present inventive concept, the pulse rate of the first pulse signal 5 may be lowered to half (½) of its original value.

As shown in FIG. 10, for the time period t1 , the number of pulses of the first pulse signal 5 is 3, and the number of pulses of the second pulse signal 13 is 1, and for the time period t4, the number of pulses of the first pulse signal 5 is 2, and the number of pulses of the second pulse signal 13 is 1. In addition, assuming that the first pulse signal 5 has a pulse rate of, for example, 60 Hz, the converted second pulse signal 13 will sequentially have pulse rates of 20 Hz and 30 Hz. The recomputed upper limit value 3 may be input (e.g., directly input) to the pulse counting unit 10.

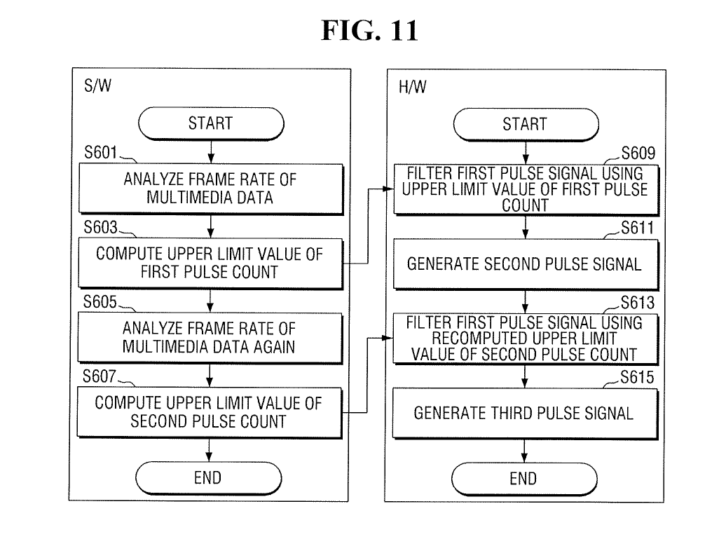

FIG. 11 is a flowchart illustrating a method for controlling a semiconductor device according to an exemplary embodiment of the present inventive concept.

Referring to FIG. 11, the method for controlling the semiconductor device according to an exemplary embodiment of the present inventive concept may be performed using software and hardware implementations.

Referring to the software implementation, the processing unit 130 of the computing system 100 analyzes a frame rate of the multimedia data 310 to be reproduced in the display module 200 at S601, and an upper limit value 3 of a first pulse count is computed based on the frame rate of the multimedia data 310 and the pulse rate of the first pulse signal 5 generated by the display module 200 at S603. The computed upper limit value 3 of the first pulse count and the first pulse signal 5 may be input (e.g., directly input) to the pulse counting unit 10 of the pulse signal control unit 1. Next, referring to the hardware implementation, the first pulse signal 5 may be filtered using the upper limit value 3 of the first pulse count at S609, and the second pulse signal 13 may then be generated at S611.

Thereafter, referring to the software implementation, if the frame rate of the multimedia data 310 is changed, the processing unit 130 of the computing system 100 analyzes the frame rate of the multimedia data 310 again at S605, and a recomputed upper limit value 3 of a second pulse count is recomputed based on the changed frame rate of the multimedia data 310 and the pulse rate of the first pulse signal 5 generated by the display module 200 at S607. The recomputed upper limit value 3 of the second pulse count and the first pulse signal 5 may be input (e.g., directly input) to the pulse counting unit 10 of the pulse signal control unit 1. Next, referring to the hardware implementation, the first pulse signal 5 is filtered using the recomputed upper limit value 3 of the second pulse count at S613, and a third pulse signal 13 may then be generated at S615.

As described above, according to exemplary embodiments of the present inventive concept, in an exemplary scenario, even when it is not necessary to renew the multimedia data at a rate of 60 Hz (e.g., even when the frame rate of the multimedia data does not reach 60 Hz), the display controller 110 may be prevented from collectively providing the image data to the display module 200 or reading the image data from the external memory 300, thereby reducing overhead relating to inputting/outputting data and reducing unnecessary power consumption. In addition, according to exemplary embodiments, the aforementioned processing work may be implemented using a hardware implementation using, for example, a system-on-chip (SoC), thereby reducing a work load of the processing unit 130 of the computing system 100.

Hereinafter, an electronic system including semiconductor devices according to exemplary embodiments of the present inventive concept will be described.

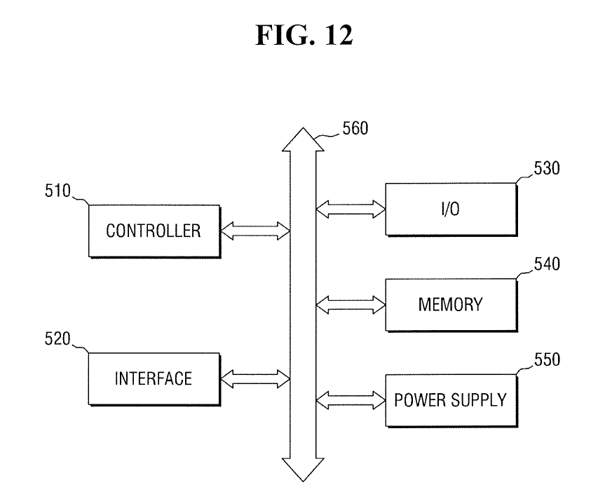

FIG. 12 is a schematic block diagram illustrating an exemplary electronic system including semiconductor devices according to exemplary embodiments of the present inventive concept.

Referring to FIG. 12, the electronic system may include, for example, a controller 510, an interface 520, an input/output (I/O) device 530, a memory 540, a power supply 550, and a bus 560.

The controller 510, the interface 520, the I/O device 530, the memory 540, and the power supply 550 may be connected to each other through the bus 560. The bus 560 may correspond to a path through which data is transmitted and received.

The controller 510 may include at least one of, for example, a microprocessor, a microcontroller, and logic components. The interface 520 may perform functions of, for example, transmitting data to a communication network or receiving data from the communication network. The interface 520 may be wired or wireless. For example, the interface 520 may include an antenna or a wired/wireless transceiver.

The I/O device 530 may include, for example, a keypad, a display device, a touchscreen, etc., and may input/output data.

The memory device 540 may store data. The semiconductor memory devices according to exemplary embodiments of the present inventive concept may be included components of the memory device 540.

The power supply 550 may convert externally input power and then provide the converted power to various components of the electronic system (e.g., components 510 to 540).

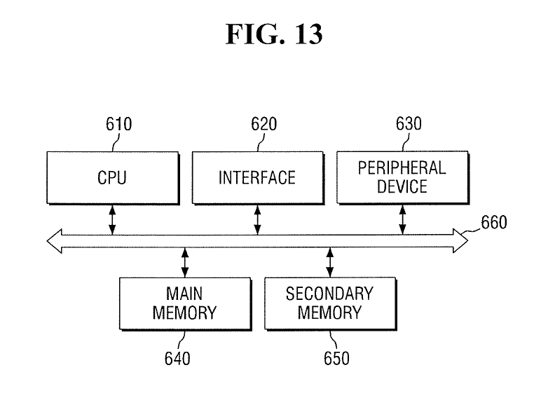

FIG. 13 is a schematic block diagram illustrating an exemplary electronic system including semiconductor devices according to exemplary embodiments of the present inventive concept.

Referring to FIG. 13, the electronic system may include, for example, a central processing unit (CPU) 610, an interface 620, a peripheral device 630, a main memory 640, a secondary memory 650, and a bus 660.

The CPU 610, the interface 620, the peripheral device 630, the main memory 640, and the secondary memory 650 may be connected to each other through the bus 660. The bus 660 may correspond to a path through which data is transmitted and received.

The CPU 610 may include, for example, a controller, an operation device, etc., and may execute a program and process data.

The interface 620 may transmit data to a communication network or may receive data from the communication network. The interface 620 may be configured in a wired/wireless manner. For example, the interface 620 may be an antenna or a wired/wireless transceiver.

The peripheral device 630 may include, for example, a mouse, a keyboard, a display device, a printer, etc., and may input/output data.

he main memory 640 may transmit/receive data to/from the CPU 610 and may store data and/or commands required to execute the program.

The semiconductor memory systems according to exemplary embodiments of the present inventive concept may be provided as some components of the main memory 640.

The secondary memory 650 may include a nonvolatile memory such as, for example, a floppy disk, a hard disk, a CD-ROM, or a DVD, and may store the data and/or commands. The secondary memory 650 may store data even in the event of power interruption of the electronic system.

The semiconductor memory devices according to exemplary embodiments of the present inventive concept may be provided as one of various components of an electronic device, including, for example, a computer, an ultra mobile personal computer (UMPC), a work station, a net-book, a personal digital assistant (PDA), a portable computer, a web tablet, a wireless phone, a mobile phone, a smartphone, an e-book, a portable multimedia player (PMP), a potable game console, a navigation device, a black box, a digital camera, a 3-dimensional (3D) television, a digital audio recorder, a digital audio player, a digital picture recorder, a digital picture player, a digital video recorder, a digital video player, a device capable of transmitting/receiving information in wireless environments, one of various electronic devices constituting a home network, one of various electronic devices constituting a computer network, one of various electronic devices constituting a telematics network, RFID devices, embedded computing systems, etc.

While the present inventive concept has been particularly shown and described with reference to the exemplary embodiments thereof, it will be understood by those of ordinary skill in the art that various changes in form and detail may be made therein without departing from the spirit and scope of the present inventive concept as defined by the following claims.

What is claimed is:

1. A semiconductor device, comprising:
a pulse counting unit configured to output a pulse count signal obtained by counting pulses of a first pulse signal received from a display module, and reset the pulse count signal when a value of the pulse count signal reaches a preset upper limit value;
a mask pulse signal generation unit configured to generate a mask pulse signal having a pulse corresponding to a reset period of the pulse count signal;
a logical operation unit configured to perform an AND operation on the first pulse signal and the mask pulse signal; and
a pulse signal generation unit configured to generate a second pulse signal using a signal output by the logical operation unit, wherein the second pulse signal has substantially the same pulse width as a pulse width of the first pulse signal,
wherein a pulse rate of the second pulse signal is substantially the same as a frame rate of multimedia data to be reproduced in the display module.

2. The semiconductor device of claim 1, wherein the display module comprises a liquid crystal display (LCD) module and the first pulse signal comprises a tearing effect (TE) signal received from the LCD module.

3. The semiconductor device of claim 1, wherein the pulse rate of the second pulse signal is substantially the same as or less than a pulse rate of the first pulse signal.

4. The semiconductor device of claim 1, wherein the preset upper limit value is computed based on a ratio of a pulse rate of the first pulse signal to the frame rate of the multimedia data to be reproduced in the display module.

5. The semiconductor device of claim 4, wherein the preset upper limit value is recomputed as the frame rate of the multimedia data to be reproduced in the display module changes, and the recomputed preset upper limit value is input to the pulse counting unit.

6. The semiconductor device of claim 1, wherein the second pulse signal functions as a trigger signal of a display controller configured to control the display module, and the display module is controlled using the trigger signal.

7. The semiconductor device of claim 6, wherein the display controller is configured to access a memory based on the pulse rate of the second pulse signal.

8. The semiconductor device of claim 7, wherein the display controller is configured to read an image frame stored in the memory based on the pulse rate of the second pulse signal, and transmit the read image frame to the display module.

9. The semiconductor device of claim 6, wherein the display controller and the display module are configured to interface with each other using a display serial interface (DSI) based on a mobile industry processor interface (MIPI).

10. The semiconductor device of claim 1, wherein the pulse counting unit is configured to count the pulses of the first pulse signal at rising edges of the pulses.

11. A semiconductor device, comprising:
a pulse signal control unit configured to reduce a pulse rate of a first pulse signal received from a display module, and generate a second pulse signal based on the first pulse signal;
a processing unit configured to calculate a ratio of the pulse rate of the first pulse signal to a frame rate of multimedia data stored in a memory, and control an operation of the pulse signal control unit; and
a display controller configured to transmit the multimedia data to the display module based on a pulse rate of the second pulse signal,
wherein the pulse rate of the second pulse signal is substantially the same as the frame rate of the multimedia data.

12. The semiconductor device of claim 11, wherein the pulse signal control unit, the processing unit, and the display controller are implemented as a system-on-chip (SoC).

13. The semiconductor device of claim 11, wherein the display module comprises a liquid crystal display (LCD) module and the first pulse signal comprises a tearing effect (TE) signal received from the LCD module.

14. The semiconductor device of claim 11, wherein the pulse rate of the second pulse signal is substantially the same as or less than the pulse rate of the first pulse signal.

15. The semiconductor device of claim 11, wherein the display controller is configured to access the memory based on the pulse rate of the second pulse signal.

16. A method of controlling a semiconductor device, comprising:
counting pulses of a first pulse signal received from a display module;
generating a pulse count signal based on the counted pulses of the first pulse signal;
resetting the pulse count signal when a value of the pulse count signal reaches a preset upper limit value;
generating a mask pulse signal having a pulse corresponding to a reset period of the pulse count signal;
performing an AND operation on the first pulse signal and the mask pulse signal; and
generating a second pulse signal having substantially the same pulse width as a pulse width of the first pulse signal,
wherein a pulse rate of the second pulse signal is substantially the same as a frame rate of multimedia data to be reproduced in the display module.

17. The method of claim 16, wherein the pulse rate of the second pulse signal is substantially the same as or less than a pulse rate of the first pulse signal.

18. The method of claim 16, wherein the preset upper limit value is computed based on a ratio of a pulse rate of the first pulse signal to the frame rate of the multimedia data to be reproduced in the display module.

19. The method of claim 16, further comprising:
reading an image frame stored in a memory based on the pulse rate of the second pulse signal; and
transmitting the read image frame to the display module.

20. The method of claim 16, wherein the display module comprises a liquid crystal display (LCD) module and the first pulse signal comprises a tearing effect (TE) signal received from the LCD module.
